(19) United States
(12) Patent Application Publication
(10) Pub. No.: US 2009/0121387 A1
(43) Pub. Date: May 14, 2009

(54) Apparatus and Method for Manufacturing Plastic Products

(75) Inventor: Hendricus Antonius Hoogland, Wormer (NL)

Correspondence Address: HOFFMANN & BARON, LLP, 6900 JERICHO TURNPIKE, SYOSSET, NY, 11791, US

(73) Assignee: ECIM TECHNOLOGIES B.V., LC Capelle A/D Ijssel (NL)

(21) Appl. No.: 11/665,395

(22) PCT Filed: Oct. 11, 2005
(86) PCT No.: PCT/NL2005/000732

§ 371 Date: Jul. 25, 2007

(30) Foreign Application Priority Data
Oct. 15, 2004 (NL) 1027261

(51) Int. Cl. B29C 45/32; B29C 47/12; B29C 45/12

(52) U.S. Cl. 264/297.2; 425/585; 425/462; 425/463; 264/328.8

(57) ABSTRACT

An injection molding apparatus (100) comprising a supply device (114) for at least partially molten plastic and at least two molds (103), wherein each mol comprises at least one mold cavity (30) defined by at least a first mold part (24) and a second mold part (25), while a distributor (104) is provided which carries the first mold parts and connects the mold cavities with the supply device.

This invention relates to an apparatus for manufacturing plastic products, in particular by injection molding, compression-injection molding or similar technique.

For injection molding, usually, an injection mold having one or more mold cavities, in one or more layers, is used. In use, plastic in molten condition is introduced from a supply device such as an extruder into the mold cavity. To that end, the mold, at least a first part thereof, is mounted on a fixed mounting plate of a press, such that an inlet end of a channel extending through the respective mold part and terminating in the or each mold cavity, aligns with an outlet opening of the supply device. A second part of the mold is mounted on an opposite, movable mounting plate of the press, so that by means of the press the mold can be opened and closed and in particular can be held closed during and directly after the filling of the mold cavity or cavities. This is of particular importance since injection of the plastic in conventional injection molding processes involves a particularly high injection pressure, especially when forming products with relatively long, thin flow paths and/or complicated flow paths.

An advantage of molds with multiple mold cavities over molds with a single mold cavity is that they enable the simultaneous production of multiple products in a single injection molding cycle. A disadvantage is that they are relatively costly and complicated and, moreover, that a problem in one of the mold cavities leads to stagnation of production in all mold cavities.

One object of the invention is to provide an apparatus for manufacturing plastic products that is relatively simple in structure and in use and affords a user a relatively great freedom in use.

Another object of the invention is to provide such an apparatus that enables different products to be made simultaneously.

Yet another object of the invention is to provide an apparatus for manufacturing plastic products that simplifies maintenance.

A further object of the invention is to provide an apparatus for manufacturing plastic products by injection molding, with which, on a relatively small press, products can be manufactured with a relatively large projected surface and relatively long, narrow flow paths.

A still further object of the invention is to provide an apparatus for manufacturing plastic products that is relatively inexpensive in makeup and maintenance.

A yet further object of the invention is to provide an apparatus and method that enable relatively fast and simple manufacture of complicated, three-dimensional products such as containers, crates and the like, in large numbers and with short cycle times.

At least a number of these and further objects are achieved with an apparatus and/or method according to the present invention.

In an apparatus according to the present invention, at least two separate molds are provided, which are jointly connected to a supply device for plastic, such as an extruder, with the aid of a distributor. First mold parts of the molds are mounted on the distributor and, using suitable means therefor, second mold parts can be moved against the first mold parts for closing the molds.

It will be immediately clear, incidentally, that also more complicated molds can be used, for instance molds built up in multiple parts, stack molds and the like.

Distributor should herein be understood to mean at least a device through which extends a channel system that brings the supply device into fluid communication with the mold cavities of the molds arranged on the distributor, at least the channel parts that extend through the molds from the mold cavities and, in the normal use of molds, are connected directly to a supply device for plastic. The distributor therefore serves to distribute plastic from the supply device over the different molds.

By the use of a distributor, the advantage is achieved that a series of molds can be used, each by itself forming a complete injection mold. The molds may be made of identical design, so that a considerable saving on the cost of the individual molds can be achieved. In this way, a series of mold cavities can be obtained in a relatively inexpensive manner in proportion to a multiple mold having the same number of mold cavities, especially if complicated molds are used, for instance provided with moving parts such as movable cores, wall parts and the like, collapsible cores, inserts and other complicating elements. A further advantage of such an apparatus is that always a desired number of molds can be placed, depending on the demand for the respective product to be formed therein, while moreover different molds can be used simultaneously in one and the same apparatus. Thus, for instance, different products can be manufactured simultaneously, while in each case, depending on demand, molds can be exchanged. A further advantage of such an apparatus is that in case of malfunction in one of the molds, at least mold cavities, the whole respective mold can be taken out and replaced. This is especially advantageous if relatively complicated molds, at least cavities, are used. Thus, down time of the apparatus is limited to a minimum.

In a particularly advantageous embodiment, an apparatus according to the invention is characterized by the features according to claim 6.

Such an apparatus provides the advantage of allowing complicated products to be manufactured in a relatively simple manner. In particular, it allows products to be manufactured with proportionally very low pressures and hence low closing forces compared to the injection molding of such products in a conventional manner with fixed mold cavities, that is, without movable wall parts.

In this description, retracted position of the or each movable wall part of a mold cavity should be understood to mean at least a position in which the volume of the respective mold cavity is greater than the volume of a product to be formed in the respective mold cavity. Forwardly moved position should be understood to mean a position in which the respective wall part has been moved from the retracted position, such that the volume referred to has been reduced with respect to the volume in the retracted position.

Rise of the temperature above the melting temperature of a plastic as a result of the adiabatic heat development should herein be understood to mean at least that in at least a portion of the plastic such heat development occurs that a temperature rise is obtained, so that the plastic becomes more liquid, i.e. the viscosity is lowered. The temperature can then be held above the melting temperature of the respective plastic or be raised so as to exceed the melting temperature again.

Surprisingly, it has been found that through supply of energy to the plastic by the movable wall parts, with particular advantage, the melt of the plastic can be influenced, at least locally, so that the flow of the plastic in the mold is positively affected. By first bringing the or each wall part in a retracted position, the plastic can moreover be introduced into the or each mold cavity of each mold with a lower pressure. Tests performed seem to indicate that the energy required for moving the or each wall part is lower than the extra energy that would have to be used in a conventional injection molding process for a same product to keep the or each mold closed and to heat and introduce the plastic, compared with the energy required for that in the use of an apparatus as proposed here. Without wishing to be bound to any theory, this seems to be due to at least the lower required closing force, thus allowing a lighter machine to be used and the molds to be made of lighter design, a lower temperature of the plastic at injection into the molds, so that less energy needs to be used for the heating, and a lower injection pressure, so that less energy needs to be used to adjust the plastic to the required pressure and to maintain such pressure. Moreover, it has been found that no, at least less, hold pressure needs to be applied to control stresses, deformations and the like.

Precisely with such an apparatus, moreover, the advantage is achieved that two or more molds can be arranged simultaneously in a press, in which, in the case of conventional injection molding, only one mold can be arranged. Thus, optimum use can be made of an available output of a press, at least holding means and closing means.

With an apparatus according to the invention, in particular as characterized by at least the features according to claim 9, it has been found that crate-shaped products can be manufactured particularly advantageously. With such molds, movable wall parts can be used that move in a direction including an angle with the closing direction of the molds and of a press possibly to be used therewith. This is not possible in conventional injection molding technique without using particularly heavy mold and press constructions, nor in compression or compression-injection molding.

In this description, crate-shaped product should be understood to mean a product having at least a bottom and sidewalls extending from the bottom, jointly defining an inner space. The bottom and/or the sidewalls can then be wholly or partly continuous and can be wholly or partly single-walled, double-walled or multi-walled. In the inner space, partitions or other dividing elements such as compartments and the like may be arranged.

The invention further relates to a distributor and an assembly of a distributor and a series of molds.

The invention furthermore relates to a method for manufacturing plastic products, characterized by the features according to claim 15.

In the further subclaims, further advantageous embodiments of a mold, assembly, method and product according to the invention are described. To clarify the invention, embodiments of a mold, assembly, method and product according to the invention will be further elucidated with reference to the drawing, in which:

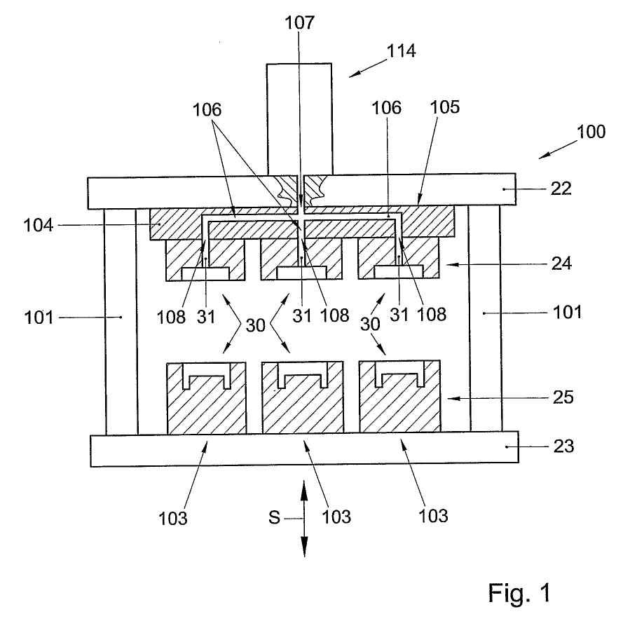

FIG. 1 schematically shows in side elevation and partly in cross section an apparatus according to the invention;

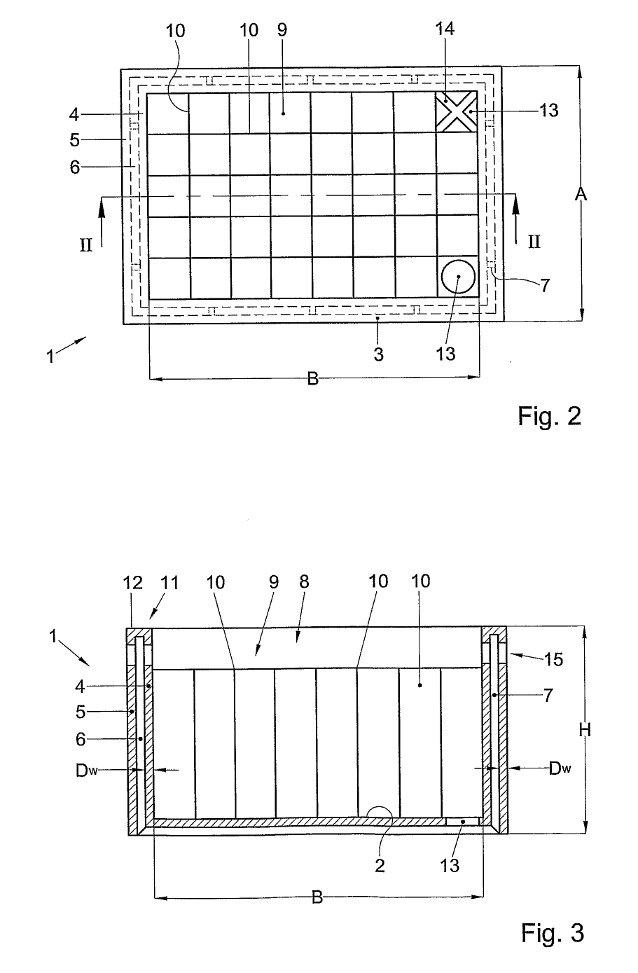

FIG. 2 shows in top plan view a holder according to the invention, here shown as a crate;

FIG. 3 shows in sectional side elevation along the line II-II in FIG. 2 a holder according to the invention;

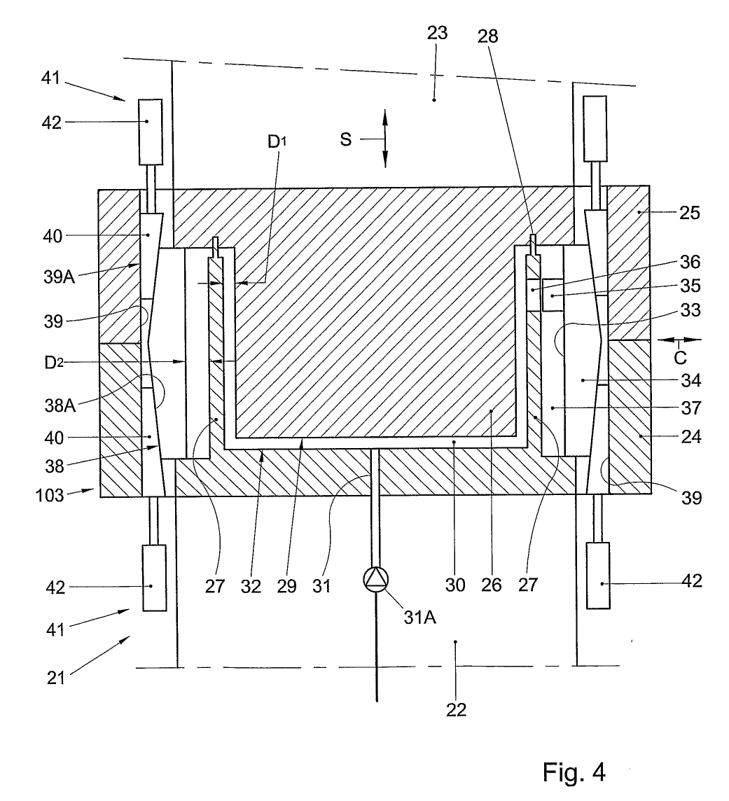

FIG. 4 shows in sectional side elevation a mold according to the invention, placed in a press, in closed condition with a mold cavity at maximum volume, that is, with retracted movable wall parts, sectioned along a plane corresponding to the section of the holder as shown in FIG. 3;

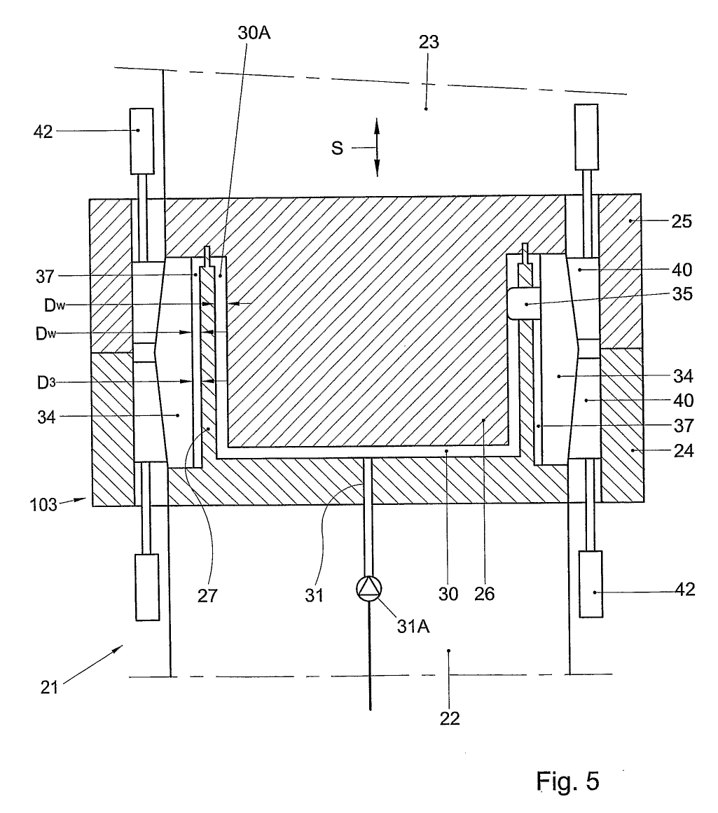

FIG. 5 shows the mold according to FIG. 4, with forwardly moved wall parts;

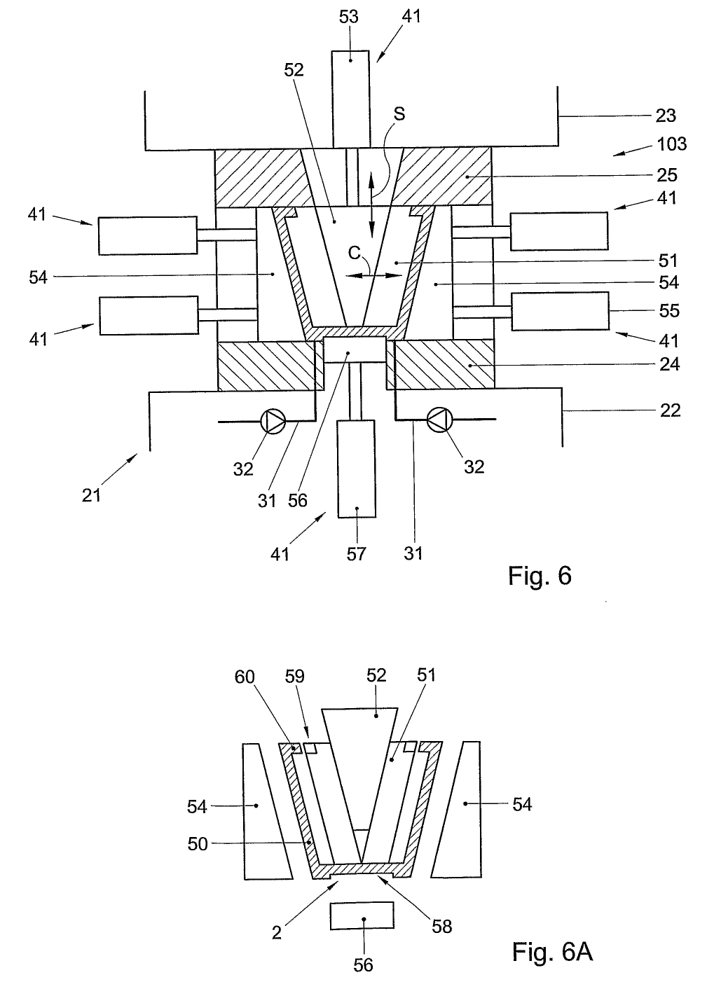

FIG. 6 shows in sectional side elevation similar to FIGS. 4 and 5 a mold according to the invention, in an alternative embodiment;

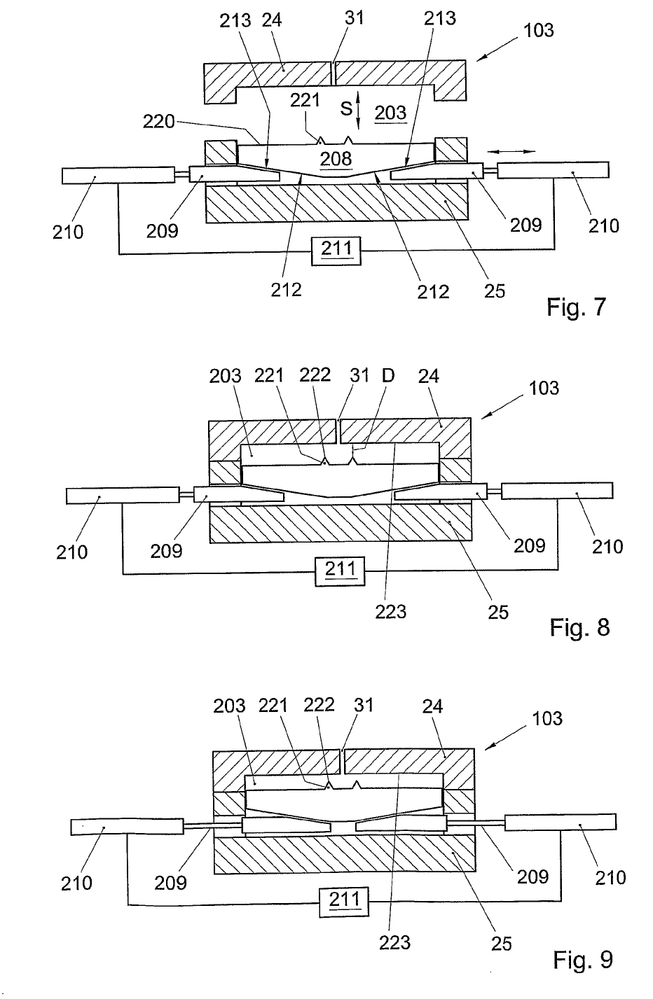

FIG. 7 shows in partly sectional side elevation an apparatus according to the invention, with a partly opened mold;

FIG. 8 shows in partly sectional side elevation an apparatus according to the invention, with a closed mold and retracted slide;

FIG. 9 shows in partly sectional side elevation an apparatus according to the invention, with a closed mold and forwardly moved slide;

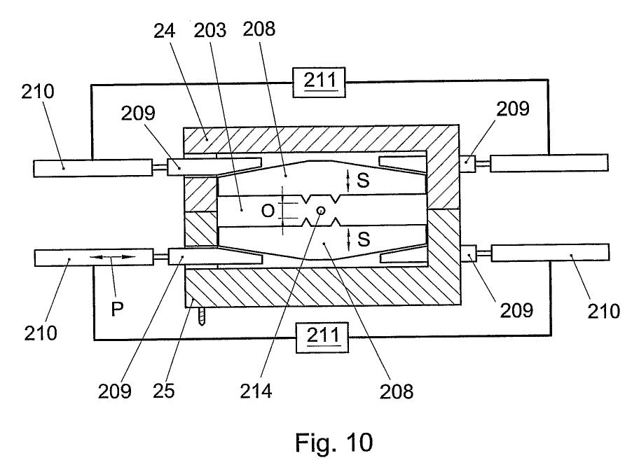

FIG. 10 shows in partly sectional side elevation an alternative embodiment of an apparatus according to the invention; and

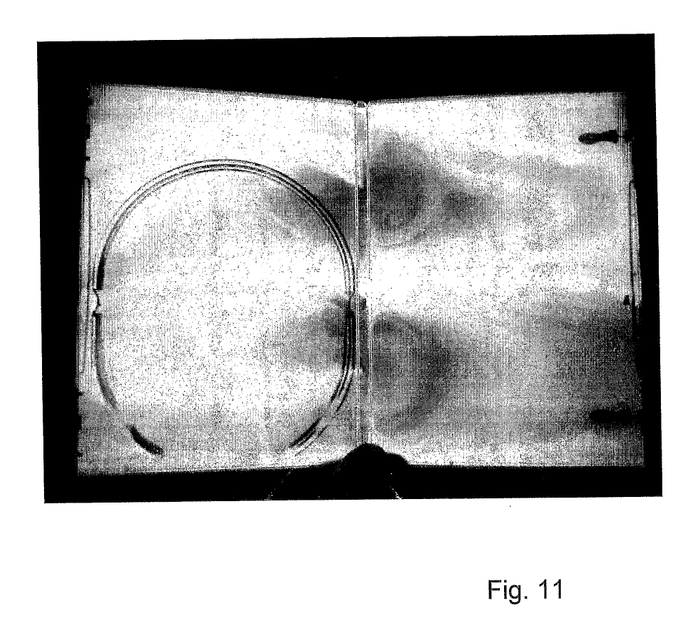

FIG. 11 shows a depiction of a CD box manufactured according to the invention, photographically fixed using dye.

The embodiments shown are only given by way of example and should not in any way be construed as limiting the invention.

FIG. 1 schematically shows in partly sectional side elevation an apparatus 100 according to the invention. There is schematically shown a first holding plate 22 and a second holding plate 23 of a press (not further shown) guided by bars 101 as is conventional in the injection molding technique. The second holding plate 23 is movable relative to the first holding plate in the direction S.

Arranged on the first holding plate 22 are a series of first mold parts 24, while complementary second mold parts 25 are arranged on the second holding plate 23. In respective pairs, the first and second mold parts 24, 25 form a mold 103. Provided adjacent the first holding plate 22 is a supply device 114, with which, in a known manner, plastic can be supplied for injection into mold cavities 30 in the molds 103. Arranged between the first lo mold parts 24 and the first holding plate 22 is a distributor 104. This distributor comprises a channel system 105 with channels 106 which extend between an inlet 107 connected with the supply device and a series of outlets 108. Connected to each outlet 108 is a feed channel 31 of a mold 103. Via the distributor, therefore, the different mold cavities 30 can be filled with plastic. The channels 106 are laid out such that filling of the different mold cavities 30 proceeds equally. To that end, the flow resistance of the different channels has been adapted.

Eligible for use as molds 103 are conventional injection molds or compression-injection molds. These will not be further described here. Preferably, however, molds are used that are provided with movable wall parts, so that during use adiabatic heat development can be generated in the plastic in the different mold cavities. As a result, considerable advantages are achieved. Embodiments of such molds will be described and discussed hereinafter, as individual molds. Such molds can be combined in an apparatus according to FIG. 1.

FIG. 2 shows, in top plan view, a holder 1 according to the invention, in the form of a bottle crate, to which the invention is not limited. FIG. 3 shows the holder 1 in cross-sectional side view. This holder 1 comprises a bottom surface 2 and a longitudinal wall 3 extending therefrom. The longitudinal wall 3 is substantially double-walled, which means that it comprises a first wall 4, a second wall 5 and, located therebetween, a cavity or open space 6. The wall thickness Dw is relatively small with respect to the dimensions A, B of the bottom surface 2 and the height H. The wall thickness can be, for instance, between a few tenths of a millimeter and a few millimeters, depending on, for instance, the holder dimensions, intended use and the like. Between the walls 4, 5, cross partitions 7 can be provided, preferably of a comparable wall thickness, for stiffening and enlarging the bearing capacity. Within the longitudinal wall 3 and the bottom surface 2, an inner space 8 with a compartmentation 9 is provided by cross walls 10. They reach to a point below the upper side 11 of the longitudinal wall 3. The top ends of the walls 4, 5 are interconnected by a carrier edge 12, preferably of a wall thickness comparable to that of the walls 4, 5. In the bottom surface 2, openings 13 can be provided, for instance circular, as shown at the bottom right-hand side, or formed by cross bars 14, as shown at the top right-hand side. By providing openings, material and weight, cooling time and/or closing pressure can be limited. In the longitudinal wall 3 handles 15 are provided at opposite sides.

A holder 1 according to the invention can for instance be manufactured in a mold 103 according to FIGS. 4 and 5. Naturally, the first direction of movement S can have any orientation, for instance vertical as shown in FIGS. 4 and 5, but also horizontal, by tilting the press.

The second part 25 comprises a central core part 26, for forming the internal space 8 of the holder 1. This central core part 26 is surrounded on all sides at a distance D1 by a second core part 27 provided on the first part 24 of the mold 103. The distance D1 corresponds to the wall thickness D of the first wall 4 of the holder 1. The second core part 27 corresponds in shape to the shape of the cavity 6 in the longitudinal wall 3 of the holder 1. Optionally, pins 28 can be provided in the upper side of the second core part 27, that fit into recesses in the second part 25 of the mold to support it. As a result, openings are formed in the edge 12. Between a leading end 29 of the central core part 26 and the first part 24, a space 30 is left open for forming the bottom surface 2. In this space 30 terminates a supply opening 31 through which plastic can be introduced into the mold cavity 32.

On the side of the second core part 27 facing away from the central core part 26, in the embodiment shown, on four sides, a movable wall part 33 is provided in the form of a slide 34 which is movable in a second direction of movement C. The surface facing the second core part 27 has the form of the outside of the respective part of the longitudinal wall 3. Optionally, on the slide 34, a projection 35 can be provided for forming the handle 15, which projection, to that end, can reach through an opening 36 in the second core part 27. For the sake of simplicity, projection 35 and opening 36 are only drawn on the right-hand side.

In the position shown in FIG. 4, the slides 34 are shown in a retracted position, i.e. at a distance D2 from the second core part 27 which is greater than the desired wall thickness D3 of the second wall 5. Hence, between the slide 34 and the adjacent core part 27, a relatively great, wide space 37 is provided, through which plastic can flow readily and without much resistance.

On the rear side of the slide 34, inclining surfaces 38 are provided, in the embodiment shown two surfaces 38 inclining in opposite directions. Further, a flat running surface 39 is provided behind the slide, i.e. on the side thereof facing away from the second core part 27. Provided between the inclining surfaces 38 and the running surface 39 are wedges 40 with corresponding inclining surfaces 38A and running surfaces 39A. The wedges 40 are connected with drive means 41, in FIGS. 4 and 5 designed as piston-cylinder assemblies 42, with which the wedges 40 can be moved from the first position shown in FIG. 4 to a second position shown in FIG. 5, and vice versa. By moving the wedges 40 to the second position, the slides 34 are moved inwards, i.e. towards the second core part 27. Consequently, the space 37 is reduced and plastic present therein is thereby displaced and/or somewhat compressed.

A mold 103 with press 21 can be used as follows.

The mold 103 is brought into the closed position shown in FIGS. 4 and 5 and held closed by the press with a relatively light closing pressure. The closing pressure is smaller than is necessary for injection molding a similar holder with the aid of conventional injection molding technique and injection mold, which can be customarily determined from, chiefly, the projected surface in the direction S, the flow paths, in particular the wall thicknesses, and the plastic used.

The slides 34 are brought into the retracted, first position, after which, via the supply opening 31, with the aid of means 31A suitable therefor, plastic is introduced into the space 30, preferably in molten, at least substantially liquid form. From the space 30, the plastic flows via the spaces 30A between the central core part 26 and the second core part 27 over the second core part 27 into the spaces 37. Since the plastic experiences virtually no resistance in the spaces 37, it can easily flow into them without unwanted pressure build-up and/or solidification of the plastic. Then, when substantially all needed plastic has been introduced into the mold cavity 32, the drive means 41 are energized, so that the wedges 40 are moved to the second position and the slides 34 are forced in the direction of the second core part 27. The plastic is thereby forced further into the mold cavity 32, in particular as far as the end of the space 37, so as to fill it completely.

As the direction of movement C includes an angle with the direction of movement S, a favorable load of the different parts is obtained. As the plastic can flow into and through the mold cavity 32 without much resistance, relatively low pressures can suffice. As a result, for instance, bending of the second core parts 27 is prevented and excessive wear is controlled. Moreover, as a result of this too, the required closing force can be kept low.

After the slides have been moved forwards maximally, the plastic can solidify and after optional retraction of the slides and after opening of the mold 103, the holder 1 can be taken out. As a result of the relatively low injection pressure, the product will be virtually stressless.

In FIGS. 4 and 5, the openings for forming the partition walls 10 have been omitted for clarity.

The slides 34 of a mold 103 can be moved so rapidly that adiabatic heat development occurs in the plastic. As a result, the flow properties of the plastic can be improved still further and any plastic which has possibly solidified can be made liquid again. Alternatively, the slides 34 can also move slowly, so that the plastic is not heated, or heated only to a very limited extent, and already solidifies slightly during introduction. Also, it may be elected to move the slides in the direction of the second position already during introduction of the plastic (FIG. 5), so that the plastic is held in motion continuously. This can be advantageous in particular in the case of, for instance, crystalline plastics and plastics having a glass transition point and/or a low melt or when product properties of the plastic are to be accurately preserved.

FIG. 6 schematically shows a mold 103 in an alternative embodiment. This mold 103 is suitable for forming a substantially frustoconical holder 50. In this embodiment, the first core part 27 comprises two first slides 51, which are movable in a second direction of movement C. Between the first slides 51, a first wedge 52 is included which, with the aid of a drive means 41, for instance an electrically drivable screw spindle 53, is movable in the first direction S. Upon movement, being downward in FIG. 6, of the wedge 52, the first slides 51 are moved outwards, to a product-forming second position. On the outside of the mold 103, at least of the mold cavity 32, second slides 54 are provided, drivable by, for instance, drive means 41 in the form of piston-cylinder assemblies 55, between a retracted first position and a forwardly moved second position. Below the mold cavity 32, a third slide 56 is provided, movable in the first direction S with the aid of drive means 41, for instance in the form of, again, a piston-cylinder assembly 57.

In FIG. 6A, the different slides 51, 54 and 56 are shown in the retracted second position, in FIG. 6 in the forwardly moved first position, both around a holder 1. As is clearly apparent from the Figures, in the slides, in particular in the first slides 51, undercuts 59 may have been provided, for instance in an edge area thereof, so that projections 60, ribs, grooves or the like can be provided in the holder which otherwise would not be clearing. In the bottom surface 2 of the holder 1, a thinned portion 58 has been provided by pushing the third slide 56 further.

FIG. 7 shows in cross sectional view an apparatus according to the invention, provided with a mold 103 having therein a mold cavity 3. The mold comprises a first, movable part 24 and a second, complementary and fixedly arranged part 25.

In the second part 25, a slide 208 is provided, movable in the direction S between a retracted position shown in FIGS. 7 and 8, and an extended position shown in FIG. 9. For moving the slide 208, two wedge-shaped elements to be called wedges 209 are provided, which are movable in a direction P with the aid of piston-cylinder assemblies 210 which are, for instance, hydraulically driven from a central control unit 211. The wedges 209 move in the direction P approximately at right angles to the direction S. At the underside, the slide 208 is provided with two surfaces 212 inclining in opposite directions, complementary to the top surfaces of the wedges 209, such that if the wedges 209 are moved inwards, towards each other, the slide 208 is moved upwards (directions viewed in the plane of the paper) to the extended position and vice versa.

An inflow opening 31 terminates in the mold cavity 203.

On the top surface 220 of the slide 208, by way of example, two ribs 221 are provided which extend throughout the width of the slide 208, at right angles to the plane of the paper. The distance D between the end 222 of the ribs 221 leading in the direction of movement, and the opposite surface 223 of the mold cavity is set with the slide 208 in retracted position, depending on the desired product wall thickness and the plastic to be used, the distance being set greater according as the melt of the plastic is higher and/or the melting temperature of the plastic is lower.

With an apparatus according to FIGS. 7-9, a product, for instance a sheet with two hinges, can be formed from a thermoplastic such as polypropylene or polyethylene, as follows.

The mold 103 is closed from the position shown in FIG. 7, as shown in FIG. 8. The distance D is then set at a suitable value, such that the space in the mold cavity 203 is relatively great. Through the inflow opening 31, plastic is introduced into the mold cavity under relatively low pressure, for instance at a pressure of between 1 and 10 bars excess pressure. The filling pressure is selected such that a desired, short feed time is achieved without the material properties of the plastic being adversely affected and without undesirably high pressure occurring in the mold cavity. Then, at a relatively high speed, the slide 208 is moved forward, in the direction of the extended position, as shown in FIG. 9, by moving the wedges 209. Here, the speed is selected depending on the desired adiabatic heat development which should be such that the temperature of the plastic is at least substantially readjusted to approximately the melting temperature thereof. As a result, any slightly solidified plastic reliquefies and can be forced further into the mold so that a complete filling of the mold cavity is obtained while the product can have wall thicknesses which are actually too small for the melt flow index of the respective plastic/product combination. Optionally, after moving the slide, some hold pressure can be applied with the aid of the injection device 114, so that undesired stresses can be pressed from the product.

After that, the mold can be opened again and the product can be taken out.

The rate of movement of the or each slide is preferably so high that the time of movement of the slide between the retracted and the extended position is relatively short with respect to the cycle time for the manufacture of a product, for instance between 0 and 10% of that time, also depending on the desired adiabatic heating. This can be experimentally determined for each plastic/product combination or be calculated with the aid of standard tables regarding plastics, the product properties such as dimensions and flow paths, the friction that will occur when moving the slide, and the heat capacity and melting temperature of the plastic.

In FIG. 10, an alternative embodiment of an apparatus according to the invention is shown. In this embodiment, the plastic is introduced via a side inflow opening 214 and a slide 208 is provided on both sides of the mold cavity 203. In this embodiment, the slides can be moved independently of each other, but it is preferred that they be moved in coupled relation, so that a symmetrical load occurs in the mold 103.

By way of illustration, an embodiment of a mold and method according to the invention will be described. As a product example, a plastic file is taken. In Table 1, the data of the injection molding machine are listed, in Table 2 the mold data, in Table 3 the product dimensions, in Table 4 the data on the slides or pressure plate, and in Table 5 the data on operational parameters. In Table 6, the pressures and speeds used during an injection molding cycle are listed. Next, graph 1 represents the temperature in the plastic in a mold according to the invention during an injection molding cycle, plotted against time.

TABLE 1
Machine data

| Machine | Stork SX 3000-2150 | |
|---|---|---|
| Machine number | X 2936 | |
| Year of construction | 2000 | |
| Main feed | 400 V 50 Hz | |
| Main current | 354 | A |
| Control voltage | 24 | V |
| Max Oil pressure | 210 | bar |
| Max Air pressure | 8 | bar |
| Weight closing force | 8700 | kg |
| Weight Injection force | 5000 | kg |
| Screw diameter | 65 | mm |

TABLE 2
Mold data

| | | |
|---|---|---|
| Length | 1050 | mm |
| Width | 455 | mm |
| Height | 495 | mm |

| | |
|---|---|
| Number of cavities | 1 |

TABLE 3
Product size

| | | |
|---|---|---|
| Length | 655 | mm |
| Width | 320 | mm |
| Thickness | 1.7 | mm |

TABLE 4
Pressure plate data

| | | |
|---|---|---|
| Cylinder stroke | 50 | mm |
| Cylinder diameter | 80 | mm |
| Operating pressure | 300 | bar |

| | |
|---|---|
| Wedge angle | 4° |

TABLE 5
Parameters

| Mold temperature | 50° | |
|---|---|---|
| Temperature at introduction | 245° | |
| Dosing | 128 | mm |
| Shot weight | 295 | gram |
| Impact of the pressure plate | 80 | mm |
| Decompression | 10 | mm |
| Closing force | 150 | ton |
| Hold pressure | 25 | bar |
| Thrust | 20 | bar |
| Speed of impact | 0.4 | S |

TABLE 6
Cycle time

| | | |
|---|---|---|
| Sub time | At time | Total time |

| | | | | | | |
|---|---|---|---|---|---|---|
| Closing | 0.750 | S | T = 0.000 | S | 0.750 | S |
| Injection | 0.171 | S | 0.750 | S | 0.921 | S |
| Impact | 0.400 | S | 0.857 | S | 1.257 | S |
| pressure | | | | | | |
| plate | | | | | | |
| Cooling | 12.000 | S | 1.257 | S | 13.257 | S |
| Opening | 1.000 | S | 13.257 | S | 14.257 | S |
| Handling | 5.000 | S | 14.257 | S | 19.257 | S |

In a method according to the invention, at a time 0, with the mold closed, an amount of plastic was introduced into the mold cavity, sufficient for manufacturing an end product, in this case a file. In 0.1706 sec, a shot weight of 128 grams of PP was introduced into the mold cavity. The mold cavity comprised a slide with a frontal surface of approximately 200,000 mm², which was moved over a distance of 1.8 mm. The plastic was introduced at a temperature of approximately 245° C. at a speed of 750 mm/s, without pressure, at a mold temperature of approximately 50° C., and was cooled down in a first phase to approximately 230° C. At time T1, after approximately 0.107 seconds, the slide was set in motion, being moved completely forwards in approximately 0.4 sec, while the temperature in the mold rose to just below the temperature at which the plastic will decompose. From time T2, at which the slide had been moved forward completely and was held in that position, the plastic was allowed to cool down to a temperature well below the melting temperature, close to room temperature, for instance 45 to 55° C. This cooling down was done in approximately 12 seconds. Apart from two living hinges, the product thickness on the covers and the back was on average 1.7 mm by, viewed in frontal surface, 655 mm by 320 mm. During cooling down, the application of hold pressure was not necessary, as a result of the fact that no shrinkage needs to be absorbed. The product is found to be free of stress, so that a high form-stability is obtained.

As a result of the high speed of the slide, kinetic speed is converted to heat, while, moreover, friction between the plastic and the mold as well as in the plastic itself and compression lead to adiabatic heat development. Until approximately time T2 when the slide has been moved forward completely, the plastic in the mold is kept in motion and moreover held above the melting temperature, so that solidification is prevented and the flow behavior of the plastic is positively influenced. As a result, a complete filling of the mold cavity is obtained with a low closing force and filling pressure.

The mold was moved with wedges having a wedge angle of approximately 4°0.

In a method according to the invention as described here, the slide is already moved to the extended position while the plastic is being injected into the mold cavity. This also contributes to the plastic being kept in motion.

In FIG. 11, a photographic depiction is given of a CD box manufactured with a method according to the invention, clearly showing the flow pattern of the plastic. The photograph is to be explained as follows.

In the case of conventional injections, a tangle of lines would be visible. These lines (in conventional injecting) are due to the pressurized supply of plastic. A very dark, tangled pattern becomes visible, indicating there are stresses in the material. The present photograph, by contrast, shows a particularly quiet image with nice, long-threaded, light patterns. A slight hold pressure causes the two dark spots around the points of injection. In itself, this hold pressure is not requisite but hold pressure can be advantageous for improving the product still further, in particular the flatness thereof. The slightly darker spots near the center are the result of this hold pressure which has clearly remained particularly limited.

In this description, identical or corresponding parts have identical or corresponding reference numerals. In this description, by way of example, a crate has been described, in particular a crate for bottles, at least in FIGS. 2-5. However, the invention should not be construed as being limited thereto. Many other holders, which may or may not be compartmented, having bottom surfaces of a variety of different shapes, such as circular, rectangular, square, or any other shape, are possible within the framework of the invention. Also, holders can be formed with and without cavities in the side walls and/or bottom. Further, in the same or a comparable manner, also other products may be manufactured, for instance partly hollow, plate-shaped, rod-shaped, tubular or differently shaped products. The products can have a longitudinal wall or longitudinal walls extending at right angles to a bottom surface, but the or a longitudinal wall thereof can also be inclined relative to the bottom surface.

In a mold and method according to the invention, different plastics can be used, in particular thermoplastic plastics and blends. Also crystalline plastics and mixtures thereof can be used particularly well within the invention.

Further, in a mold according to the invention, different numbers and/or shapes of slides, at least moving wall parts, can be provided, which can for instance also be made of tilting design. Different types of drive means may be provided. The mold parts 22, 23 can be moved and be held closed in a different manner, while also multiple molds and/or stack molds can be built up in a comparable manner. It will further be clear that the first and second directions of movement can also include other angles than the angle of approximately 90° shown, and further the directions of movement may be different for different slides. The movements of the wedges and slides can have any desired orientation, as long as the first and a second direction of movement mutually include an angle. Also, products of a different kind may be manufactured with a mold, at least assembly, according to the invention, for instance relatively small and/or low products, tubular products and the like.

These and many comparable embodiments are understood to fall within the framework of the invention as outlined by the claims.

1. An injection molding apparatus, comprising a supply device for at least partially molten plastic and at least two molds, each mold comprising at least one mold cavity defined by at least a first mold part and a second mold part, wherein a distributor is provided which carries the first mold parts and connects the mold cavities with the supply device.

2. An injection molding apparatus according to claim 1, wherein the first mold parts are mounted on the distributor and the distributor is mounted on a first plate of a press, while the second mold parts are mounted on a second plate of the press, such that the second parts are movable relative to the first parts for opening and closing the molds.

3. An injection molding apparatus according to claim 1, wherein the distributor comprises an inlet, connected with the supply device, as well as at least two outlets, each outlet being connected with a supply channel part in a first mold part of one of the molds, while between the inlet and each outlet a channel is provided for passing through said plastic.

4. An injection molding apparatus according to claim 3, wherein said channels are shaped such that the flow resistance thereof for said plastic is approximately equal in each channel between inlet and outlet.

5. An injection molding apparatus according to claim 1, wherein said molds are equal in structure and preferably identical molds.

6. An injection molding apparatus according to claim 1, wherein each mold cavity is provided with at least one movable wall part which is movable between a forwardly moved position and a retracted position, while drive means are provided for moving each movable wall part from the retracted position to the forwardly moved position, such that after plastic has been introduced into the respective mold cavity with the respective wall part in the retracted position, the movable wall part is moved against the plastic and adiabatic heat development is obtained in said plastic, such that in it the temperature rises above the melting temperature of the plastic.

7. An injection molding apparatus according to claim 6, wherein the drive means for a movable wall part have a driving direction which includes an angle with the direction of movement of the respective movable wall part.

8. An injection molding apparatus according to claim 6, wherein each mold cavity comprises at least two movable wall parts, each having a direction of movement, which directions of movement mutually include an angle deviating from 180°.

9. An injection molding apparatus according to claim 6, wherein each mold cavity is arranged for forming a crate-shaped product.

10. An injection molding apparatus according to claim 1, wherein at least three molds are provided.

11. An injection molding apparatus according to claim 1, wherein at least two different molds are provided.

12. An injection molding apparatus according to claim 1, wherein at least one of the molds comprises at least two mold cavities.

13. An assembly of a distributor and at least two molds, suitable and intended for use in an injection molding apparatus according to claim 1.

14. A distributor for use in an injection molding apparatus according to claim 1.

15. A method for injection molding plastic products, wherein at least two molds are placed on a distributor, which distributor is provided with a channel system between a plastic inlet and a series of plastic outlets, wherein each mold is connected to at least one plastic outlet, such that plastic can be supplied therethrough to at least one mold cavity in each of the molds, wherein the distributor is connected by the inlet thereof to a supply device for at least partially molten plastic, and via the channel system said plastic is introduced from the supply device via said channel system into the mold cavities of the different molds.

16. A method according to claim 15, wherein the different molds are jointly opened and closed using a single press.

17. A method according to claim 15, wherein in each mold at least one movable wall part of a mold cavity is moved against plastic in the mold cavity during and/or directly after the introduction of said plastic into the respective mold cavity, in such a manner that in said plastic as a result of said movement of said movable wall part adiabatic heat development occurs in said plastic for lowering the viscosity of at least a part thereof.

18. A distributor for use in an injection molding assembly according to claim 13.
